(19) United States
(12) Patent Application Publication
(10) Pub. No.: US 2007/0011064 A1
(43) Pub. Date: Jan. 11, 2007

(54) Method for developing, financing and administering as asset protected executive benefit program

(76) Inventor: Dale Kenneth Edwards, Christiansted, VI (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 11/176,429

(22) Filed: Jul. 7, 2005

(51) Int. Cl. G06Q 40/00

(52) U.S. Cl. 705/35

(57) ABSTRACT

A method is provided for developing, financing and administering an asset-protected executive benefit. An employer or Investor makes an investment in an LLC whereby the employer or Investor becomes the preferred, non-managing member and is entitled to receive a guaranteed payment plus pre-established rate of return. An Executive also makes an investment in the same LLC, becomes a non-preferred, managing member and is entitled to receive value created by the LLC in excess of the amount paid to the preferred member. The LLC invests in, owns, and is the beneficiary of two life insurance policies; a Preferred Policy designed to have a death benefit equal to the investment plus cumulative guaranteed return to the preferred member, and an Investment Policy designed to meet the long-term investment objectives of the members. The Executive may instruct the LLC to borrow against the Investment Policy from which the Executive receives a cash distribution.

### TECHNICAL FIELD

The present invention relates to a process of developing, financing and administering an asset protected executive benefit program. The process can be used for key members of management, professionals, business owners, and other persons. More specifically, the present invention relates to a benefit in which the employer or alternative investor source co-invests in a Limited Liability Company (“LLC”) with a key executive of the employer, with the LLC making investments in a variety of financial instruments including life insurance. The employer of outside investor is entitled to receive a return of their investment, plus a guaranteed rate of return, and the key executive is entitled to receive any excess LLC value, in the future, in the form of distributions of cash.

### BACKGROUND OF THE INVENTION

Saving for retirement as a result of ongoing employment has become challenging, as individuals are becoming accustomed to longer retirement years with a higher standard of living. Higher income executives and business owners often have difficulty finding a safe and reliable investment vehicle that is suitable for their retirement goals. Pre-tax investment options are desirable because they allow the participant to avoid paying income tax on the money invested until after retirement, when the participant is in a lower tax bracket. However, many pre-tax investment options, such as 401(k) plans, IRAs and other qualified plans, limit the amount of annual investment to between $10,500 and $30,000 per year. Other non-qualified retirement plans have significant weaknesses, including the exposure to claims of creditors, and inflexibility in meeting individual objectives. Split dollar life insurance plans have been popular in the past, but the Internal Revenue Service has recently ruled that these plans are subject to certain levels of taxation (unless certain minimum levels of interest are charged), making historical split dollar far less attractive to executives and business owners. These limits and regulations prevent some professionals from meeting their retirement investment goals.

Employers are highly motivated to offer competitive benefits to key employees and executives of the employer. Studies consistently show that employers that provide substantial executive benefits realize lower turnover rates. Studies also consistently show that the economic cost to an employer from the loss of a key employee can be as high 3 to 5 times the annual compensation for the same key employee. However, employers are also limited in what they can provide executives and business owners. Qualified plans have low contribution limits, and non-qualified retirement plans create substantial future liabilities and high costs with little if any cost recovery. The recent IRS rulings on split dollar life insurance make that method unattractive as an incentive offered by employers, and stock options and other equity incentives are less appealing given recent market declines. Finally, employers want the opportunity to create a reasonable rate of return on any funds the employer utilizes to fund an executive benefit, and in some cases want that rate of return to be high enough that outside financing could be secured in lieu of the employer utilizing their own funds. In this way, for employers who realize a high rate of return on invested capital in their own business, they can continue to fund the business as opposed to using precious capital resources to fund a benefit plan.

It is therefore desirable to have a process and design that allows key executives, professionals, and employees the ability, in an asset-protected vehicle, to accumulate wealth for future planned purposes. while at the same time allowing the sponsoring employer to receive a competitive and guaranteed rate of return on any funds contributed by the employer. It is also desirable, in some cases, to secure outside financing in lieu of the sponsoring employer utilizing their own capital. It is desirable to accomplish this without substantially limiting the amount that can be invested and that avoids the pitfalls of other options. It is also desirable to have a benefit that provides key executives, employees, employers and other organizations with flexibility, low cost, recovery of their investment plus a rate of return, insulation from creditors and positive accounting treatment.

### BRIEF SUMMARY OF THE INVENTION

With the foregoing in mind, the present invention provides a method for developing, implementing, managing and financing a benefit that takes after-tax investments from both the employer or alternative investor, and the key executive. Specifically, after-tax investments are made into a newly created preferred return LLC by an Employer or outside financing source (the “Investor”) in exchange for owning the preferred, non-managing LLC interests. In addition, after-tax investments are made from a key executive, professional or business owner (the “Executive”) in exchange for owning the non-preferred, managing interests. The amount contributed into the LLC is determined based upon independent appraisal, and is typically 95% by the Employer or Investor and 5% by the Executive. The Employer or Investor, as the preferred member, is entitled to receive a guaranteed return of investment and guaranteed rate of return upon liquidation of the LLC, which occurs at the earlier of the death of the Executive (and in some cases their spouses) or 50 years. In this way, the invention offers a guaranteed return of capital, plus guaranteed rate of return, on any finds invested by the Employer or Investor. This is unique in the world of executive benefit plans. The Executive is entitled to receive any excess value generated by the LLC, above and beyond the Investor's preferred return, if any.

The LLC is created and domiciled in an “LLC friendly” jurisdiction under state law. Within these states, so long as the capital contributions were made by the Employer or Investor, and Executive outside a “fraudulent conveyance period,” and in the ordinary course of business, then the only recourse to a creditor of the Employer, Investor, or Executive would be a “charging order,” thereby protecting these assets from the claims of creditors. In this way, the invention offers a unique level of asset protection previously unavailable in other types of executive benefit plans, such as non-qualified deferred compensation plans.

The Operating Agreement of the LLC, as part of the invention, has been designed to accomplish all the various goals of the Employer or Investor, and the Executive. For example, the Operating Agreement stipulates a guaranteed rate of return to the Employer or Investor, the rights and responsibilities of the Executive as LLC Manager, the manner in which profits and losses are allocated, and the manner in which the LLC is liquidated.

The LLC, under the direction of the Executive as the non-preferred managing member, and within the auspices of the Operating Agreement of the LLC, oversees and manages the investments of the LLC. One of those investments will be a life insurance policy known as the “Preferred Policy.” The Preferred Policy typically will insure the Executive and his/her spouse, although other insureds are possible as long as an insurable interest exists under state law. The Preferred Policy, as part of the invention design, is designed and managed to always have a death benefit equal to the investment made by the Employer or Investor, as well as all accumulated preferred return due to the Employer or Investor. This Preferred Policy is issued by a leading AA or AAA rated carrier, and serves as the mechanism to ensure that the Employer or Investor receives their guaranteed payment at liquidation.

The LLC, under the direction of the Executive as non-preferred managing member, and after purchasing the Preferred Policy, will then take any remaining capital and purchase a life insurance policy known as the Investment Policy. The Investment Policy will be designed to potentially provide future retirement income to the Executive. At a time stipulated in the future under the Operating Agreement of the LLC, the Executive as manager can require the LLC to borrow funds against the Investment Policy. The invention is the first contemplate how life insurance policies owned by LLCs can consider and manage borrowings against that policy as part of an executive benefit program. Specifically, the invention, including the operating agreement, allows under the U.S. tax code for borrowing against the Investment Policy to be characterized as non-recourse debt. Non-recourse and Excess non-recourse debt can be allocated to a member of an LLC, which is taxed as a partnership, under Reg. Sec. 1.752-3. In this way, the Executive's basis is increased by the amount of the borrowings against the Investment Policy, thereby allowing the Executive to receive distributions from the LLC that does not exceed their basis in the LLC.

Upon the death of the insured's, which is typically the Executive and his/her spouse, the LLC calls for the allocation of tax-free death benefits from a life insurance policy. The invention including the operating agreement, consistent with U.S. tax code, allocates this tax-free income in such a way that the remaining and final distributions, both to the Employer or Investor, and the Executive, does not exceed their respective basis.

Thus, the invention simultaneously accomplishes the objectives of both parties. For the Employer, any investment in the LLC results in a guaranteed return on investment in the form of tax-free income upon the death of the Executive and his/her spouse. The level of return to the Employer is sufficient to offer an attractive rate of return that is “investment grade” in nature. The rate of return is also high enough that the Employer could seek out and secure an outside lender to provide the funds for the LLC investment. This is attractive for many Employers who have rates of return on invested capital in excess of the rate of return they would experience through the invention. In addition, for the Employer, the key members of management have any additional incentive to remain employed, which is extremely valuable to the Employer. Finally, for the Employer, the assets invested in the invention are protected from the claims of creditors, with certain conditions. For the Executive, the invention allows for the accumulation of asset-protected assets that can then be accessed by the Executive in the form of tax-advantaged distributions, so long as the preferred return to the Employer or Investor is first met. The present invention accomplishes the objectives of both parties.

### BRIEF DESCRIPTION OF THE DRAWINGS

The foregoing summary, as well as the following detailed description of the preferred embodiments, will best be understood when read in conjunction with the appended drawings, in which:

FIG. 1 is a diagram illustrating the major components of a method for developing, financing and administering an asset-protected executive benefit program.

FIGS. 2a-2e are diagrams illustrating a sequence of steps for implementing the method shown in FIG. 1.

### DETAILED DESCRIPTION OF THE INVENTION

Referring to FIG. 1, a method for developing, financing and administering an asset-protected executive benefit is illustrated. The Employer 5 either makes a pre-determined annual investment of after-tax cash into an LLC 10, or seeks out and secures financing from an outside Investor 15 to do the same. The Employer 5 or the Investor 15 typically makes a commitment to invest a predetermined annual amount into the LLC 10 for a minimum of 5 to 10 years. The Employer 5 or Investor 15 purchases and owns the preferred, non-managing interests in the LLC, entitling the Employer 5 or the Investor 15 to receive a guaranteed return on their investment upon the liquidation of the LLC. The Executive 20 also makes an investment with after-tax cash and purchases, at fair-market value, the non-preferred managing interests of the LLC. This entitles the Executive 20 to receive any value generated by the LLC that exceeds the preferred return due to the Employer 5 or the Investor 15.

The LLC invests in, owns, and is the beneficiary of two life insurance policies. The first policy, the Preferred Policy 25 is engineered as part of the invention to always have a death benefit equal to the investment plus guaranteed return due to the Employer 5 or Investor 15. The Preferred Policy will typically insure the lives of Executive 20 and his/her spouse. The LLC Operating Agreement stipulates that funds within the LLC 10 must first be used to adequately fund the Preferred Policy 25. Any remaining LLC 10 funds are used to purchase the Investment Policy 30, which is engineered as part of the invention to create cash value in the future. The Investment Policy 30 will typically insure the life of the Executive 20.

The premiums paid into the Investment Policy 30 accumulate into cash value which may earn interest and grow tax free. After an initial premium funding period, the Executive 20 may instruct the LLC 10 to borrow against Investment Policy 30, which is an assumption of non-recourse debt by the LLC 10. The LLC 10 will then allocate this non-recourse debt to the Executive 20, resulting in the basis of Executive 20 in LLC 10 being increased by the same amount. Executive 20 will then receive a cash distribution from LLC 10 which does not exceed the basis of Executive 20.

Upon the death of the insureds from the Preferred Policy 25 and the Investment Policy 30, the LLC 10 as beneficiary receives the tax-free death benefits. The LLC 10 then allocates this tax-free income to the Employer 5 or Investor 15 (as the case may be), as well as to the Executive 20, thus increasing the basis for each of these members. The result is a final distribution from the LLC 10 to each of the members equal to their respective basis.

The method for developing, financing and administering an asset-protected executive benefit program will now be described in more detail. An Employer 5 determines that it is in the best interests of the Employer 5 to offer the invention as a benefit plan to key employee(s) or executive(s) of Employer 5. An analysis is then performed to determine if it is best for the Employer 5, economically, to fund the LLC 10 interests directly, or to seek funds from an outside Investor 15. This analysis reviews the historical rate of return on invested capital experienced by the Employer 5 and compares it to an actuarial and present value analysis of the return to be expected by the Employer 5 from the LLC 10 investment. Based on this analysis, it is determined if it is best for the Employer 5 or Outside Investor 15 to make the investment in LLC 10.

The invention is then presented to the targeted employees to determine their level of interest. An analysis is conducted to show the targeted employee the potential economic benefits from the invention versus other types of personal savings or employer-sponsored benefit plans. Those targeted employees who elect to participate then move on to the next step.

The Employer 5 or Investor 15, along with the Executive, 20, then make a collective decision as to how many years and for how much to fund the LLC 10. An appraisal is then conducted to determine the fair-market value of the preferred interests to be held by the Employer 5 or Investor 15, as well as the fair-market value of the non-preferred interests to be held by the Executive 20. The Employer 5 or Investor 15, along with the Executive 20, then collectively agree to invest this amount, with after-tax funds, into the LLC 10 for an agreed upon period of years.

The LLC 10 is then formed in an asset-protection friendly state jurisdiction by filing articles of organization, by-laws, and other state-specific filings to the appropriate state authorities. In addition, a bank account is opened by the LLC 10 from which the LLC 10 receives capital contributions, makes premium payments, pays other expenses, and receives proceeds from life insurance policy investments.

A software system is then used to design the Preferred Policy 25 so that it always has a death benefit equal to the investment made by the Employer 5 or Investor 15, plus all accrued preferred return. This software system provides the data necessary to create a policy illustration to be submitted to the life insurance company issuing the Preferred Policy 25 along with an application. The LLC 10 applies for the Preferred Policy 25, with the Executive 20, along with his/her spouse, typically being the insured lives for the Preferred Policy 25. Once the underwriting requirements set by the insurance company are met, the Preferred Policy 25 is issued by the insurance company to LLC 10 as the owner and beneficiary.

A software system is then used to design the Investment Policy 30 so that it meets the investment objectives of the managing member, who is the Executive 20. This software system provides the data necessary to create a policy illustration to be submitted to the life insurance company issuing the Investment Policy 30 along with an application. The LLC 10 applies for the Investment Policy 30, with the Executive 20, typically being the insured life for the Investment Policy 30. Once the underwriting requirements set by the insurance company are met, the Investment Policy 30 is issued by the insurance company to LLC 10 as the owner and beneficiary.

Once both the Preferred Policy 25 and the Investment Policy 30 have been issued to the LLC 10 by the respective life insurance carriers, the LLC Operating Agreement is drafted and executed by the Employer 5 or Investor 15 as the preferred non-managing member, as well as by the Executive 20 as non-preferred managing member. As part of the terms of the LLC Operating Agreement, each party agrees to invest a certain amount of after-tax funds into the LLC 10 for a minimum number of years, which is typically 5-10 years. The LLC Operating Agreement also stipulates the guaranteed rate of return due to the Employer 5 or Investor 15, the manner in which profits and losses will be allocated, the manner in which non-recourse and excess non-recourse debt will be allocated, and several other issues.

Upon execution of LLC Operating Agreement, the Employer 5 or Investor 15, along with the Executive 20 make their respective after-tax capital contributions into the LLC 10. The LLC 10 then uses these funds to first pay premiums on the Preferred Policy 25. Any excess funds are used to pay premiums on the Investment Policy 30.

The Employer 5 or Investor 15, along with the Executive 20, continue to make capital contributions into the LLC 10 for the previously agreed upon investment period as stipulated in the LLC Operating Agreement. The LLC continues to make premium investments first into the Preferred Policy 25, and then into the Investment Policy 30.

The Executive 20, as managing member, actively oversees the policy investments made by the LLC 10, including in some cases making changes in investment allocations within the Investment Policy 30. The LLC 10 conducts no less than one annual meeting a year to include the Employer 5 or the Investor 15, along with the Executive 20. In addition, the LLC 10 files an annual tax return reflecting the investment activity of the LLC 10.

The face amount of the Preferred Policy 25 increases each year such that the Preferred Policy always has a death benefit equal to the initial investment, plus all guaranteed preferred return, due back to the Employer 5 or Investor 15.

The Investment Policy 30 (typically a universal life policy with some form of investment feature) performs over time based on the interaction of several variables. The Investment Policy 30 premiums and market gains contribute to growth of a cash value in the policy. Gains, however, are offset by costs, including costs of the insurance, loads, commissions, premium taxes and administrative fees assessed by the insurance company. Gains are also offset by market losses. Regardless of the actual performance of the Investment Policy 30 however, and so long as the Preferred Policy 25 has a death benefit equal to the preferred member's investment plus guaranteed return, the Executive 20 as managing member of the LLC can instruct the LLC 10 to borrow against the cash value of the Investment Policy 30.

After the initial LLC 10 capitalization period, the Executive 20 may instruct the LLC 10 to borrow against the cash value in the Investment Policy 30. This borrowing represents an assumption of non-recourse debt by the LLC 10. LLC 10 then will allocate this non-recourse debt, along with excess non-recourse debt, to the basis of Executive 20 in LLC 10. This increase in the basis Executive 20 will allow Executive 20 to receive a distribution of cash from LLC 10 equal to that same increase in basis. Executive 20 is eligible to instruct LLC 10 to do this at any time after the initial LLC 10 capitalization period.

A program administrator will monitor this borrowing activity against the Investment Policy 30 and advise the Executive 20 as to the impact of borrowings on future policy performance. In addition, a program administrator will monitor and report annual LLC 10 activity including adjustments in capital accounts, basis, policy values, rates of return, and other indicators.

Upon the death of the insured lives for the Preferred Policy 25 and the Investment Policy 30, the LLC 10 as owner and beneficiary will receive tax-free death benefit proceeds. The LLC 10 will then allocate these funds to the Employer 5 or Investor 15, along with the Executive 20, thereby increasing the basis for these LLC members. The LLC will then distribute these funds first to the Employer 5 or Investor 15, in an amount equal to their initial investment plus cumulative guaranteed return. Any remaining funds with be distributed to the Executive's 20 estate. The business affairs of the LLC 10 will then be completed and the LLC 10 will dissolve.

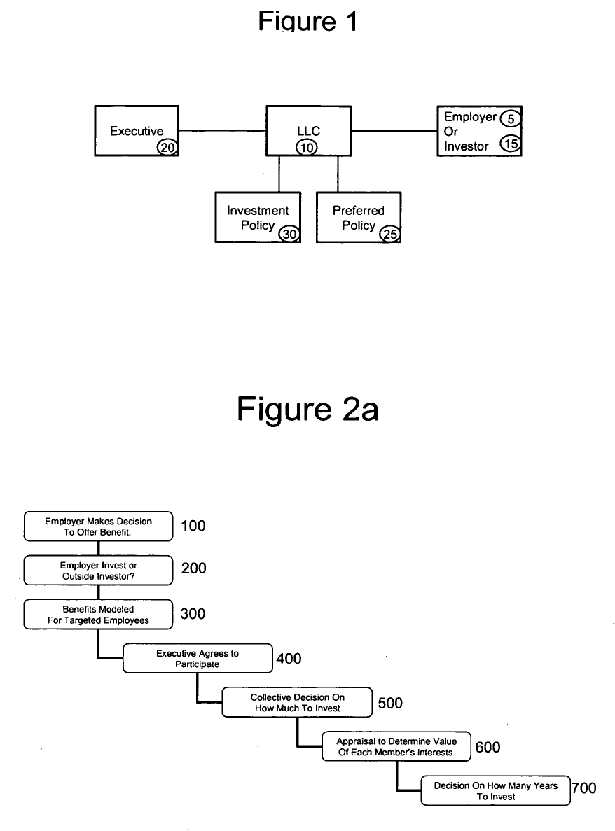

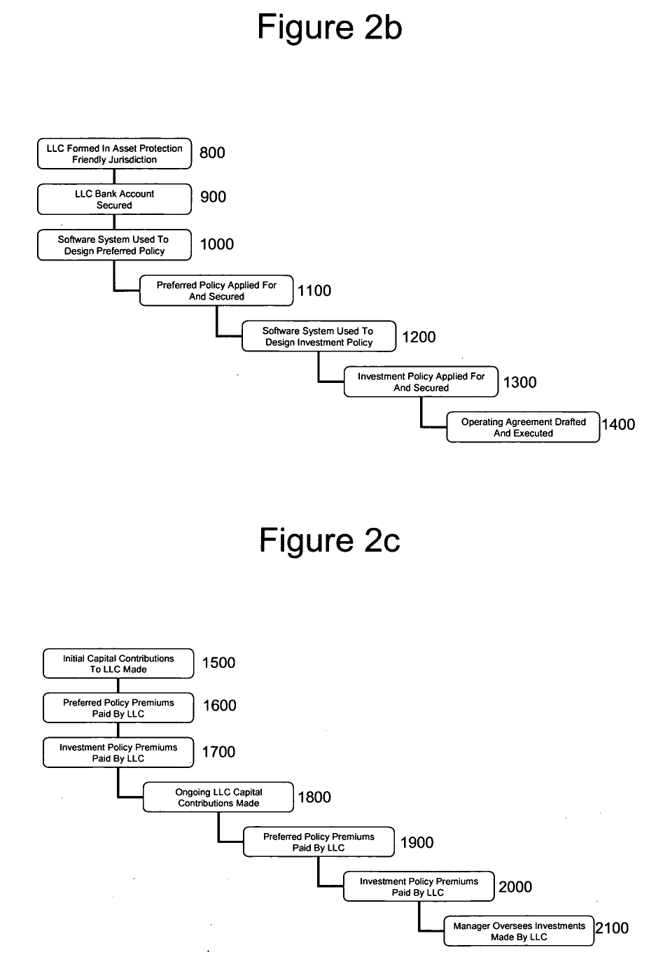

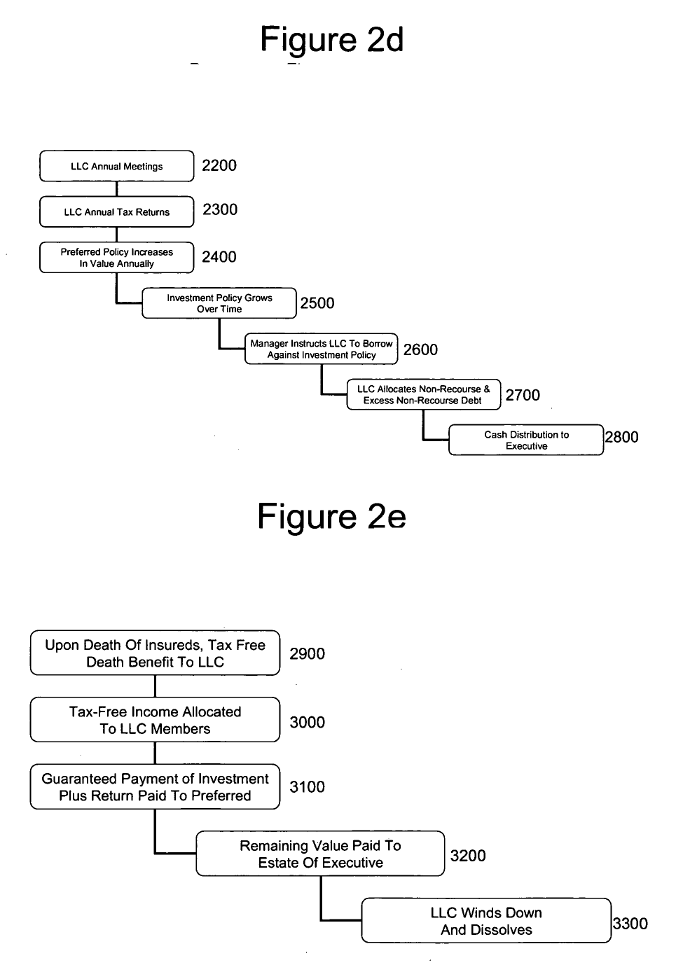

Referring now to FIGS. 2a-2e, a method for developing, financing and administering an asset-protected executive benefit program is illustrated in a block-flow diagram. The method begins with an Employer making a decision that offering the benefit to a certain number of key employees is in the best interests of the Employer 100. A software system is then used to determine if it is best for the Employer, economically, to make the LLC investment itself, or secure financing from an outside Investor to make the LLC investment 200. The benefit is then presented to targeted key employees using a software system that forecasts the potential benefits of the benefit versus other options 300, and interested key employees make a decision to move forward 400.

The Employer or Investor along with the Executive make a collective decision as to how much to invest in the LLC 500. An outside appraisal then determined how much each party should invest in the LLC as determined by fair-market value 600. The parties then agree collectively as to how many years each is willing to make investments into the LLC 700.

The LLC is then formed and organized in an asset-protection friendly jurisdiction 800, and a bank account for the LLC is secured 900.

A software system is then utilized to design the Preferred Policy 1000. The Preferred Policy is then applied for and secured from the insurance company issuing the Preferred Policy 1100. A software system is then utilized to design the Investment Policy 1200. The Investment Policy is then applied for and secured from the insurance company issues the Investment Policy 1300.

Once the Investment Policy and Preferred Policy have been issued by their respective insurance carriers, the LLC Operating Agreement is drafted and executed 1400. Upon execution of the LLC Operating Agreement, the Employer or Investor, along with the Executive, make their initial LLC capital contributions 1500. These capital contributions are then used to first pay premiums on the Preferred Policy 1600, with any remaining funds used to pay premiums on the Investment Policy 1700. The Employer or Investor, along with the Executive, then continue to make LLC capital contributions per the LLC Operating Agreement 1800, and the LLC continues to make premium investments first into the Preferred Policy 1900, and then into the Investment Policy 2000.

The Executive as managing member actively oversees the investments owned by the LLC, and in some cases makes investment re-allocations within the Investment Policy 2100. In addition, the LLC conducts annual meetings 2200 and files annual tax returns 2300.

The Preferred Policy death benefit increases in value on an annual basis equal to the cumulative preferred return due back to the Employer or Investor 2400. In addition, the Investment Policy cash value typically will grow in value over time 2500. The Executive, in the future, may elect to instruct the LLC to borrow money from the Investment Policy, which is an assumption of non-recourse debt by the LLC 2600. The LLC then allocates non-recourse and excess non-recourse debt to the Executive's basis 2700, and the Executive then takes a cash distribution from the LLC which does not exceed basis 2800.

Upon the death of the insured the LLC as owner and beneficiary of the policies receives tax-free death benefits 2900. The LLC then allocates this tax-free income to the basis of the LLC members 3000. The LLC then distributes to the Employer or Investor an amount equal to their initial investment plus cumulative guaranteed return 3100. Any remaining amount is distributed to the Executive's estate 3200, and the LLC then winds down and dissolves 3300.

The steps shown in FIGS. 2a-2e and described above are not intended to represent a preferred sequence of steps. Rather, FIGS. 2a-2e and the foregoing description are intended to illustrate the component steps of the present method in one possible sequence, with the understanding that minor variations in the sequence can be made without substantially changing the method. In addition, the terms and expressions which have been employed are used as terms of description and not of limitation. There is no intention in the use of such terms and expressions of excluding any equivalents of the steps or features shown and described or portions thereof. It is recognized that various modifications of the disclosed method are possible within the scope and spirit of the invention.

For instance, other separate parties who have a business or other relationship may have a reason to jointly invest in an the LLC arrangement described herein, and utilize the insurance policy structure described in this method.

1-19. (canceled)

20. A method for providing a benefit program, said method comprising:
organizing a business entity as a vehicle for said benefit program;
acquiring, by said business entity, a first investment for guaranteeing a return to an investor in said benefit program; and
acquiring, by said business entity, a second investment for meeting investment objectives of a beneficiary of said benefit program.

21. The method of claim 20, wherein said business entity comprises a limited liability company.

22. The method of claim 20, wherein said beneficiary of said benefit program is a non-preferred managing member of said business entity and said investor in said benefit program is a preferred non-managing member of said business entity.

23. The method of claim 20, wherein said investor in said benefit program comprises an employer of said beneficiary of said benefit program.

24. The method of claim 20, wherein said investor in said benefit program comprises an investor other than an employer of said beneficiary offering said benefit program to said beneficiary.

25. The method of claim 20, wherein said first investment comprises a first life insurance policy and said second investment comprises a second life insurance policy.

26. The method of claim 25, further comprising:
designing said first insurance policy to have a death benefit associated with said beneficiary of said benefit program sufficient to guarantee said return to said investor; and
designing said second insurance policy to allow said beneficiary to borrow finds against said second insurance policy for meeting said investment objectives of said beneficiary of said benefit program.

27. The method of claim 20, wherein said benefit program comprises an executive benefit program.

28. The method of claim 20, wherein said return to said investor comprises a guaranteed return of capital invested in said benefit program plus a guaranteed rate of return on said capital invested in said benefit program.

29. The method of claim 28, wherein said investment objectives of said beneficiary of said benefit program is met by value generated by said first and second investments which exceeds said return to said investor.

30. The method of claim 20, further comprising:
said investor in said benefit program making a predetermined annual investment into said business entity; and
said beneficiary of said benefit program making an investment into said business entity.

31. A method for providing an employee benefit, said method comprising:
forming a business entity to facilitate said employee benefit;
acquiring, by said business entity, a first insurance policy for guaranteeing a return to an investor; and
acquiring, by said business entity, a second insurance policy for meeting an investment objective of an employee being provided said employee benefit.

32. The method of claim 31, wherein said business entity comprises a limited liability company formed in a selected jurisdiction, said jurisdiction being selected as an asset-protection friendly jurisdiction.

33. The method of claim 31, further comprising:
making, by said employee, an investment into said business entity;
determining, by an employer of said employee, if the employer is to finance the benefit program;
if said employer is to finance the benefit program, making, by said employer, an investment into said business entity, said employer thus being said investor; and
if said employer is not to finance the benefit program, making, by an outside investor other than said employer, an investment into said business entity, said outside investor thus being said investor.

34. The method of claim 31, further comprising:
designing said first insurance policy to have a death benefit associated with said beneficiary of said benefit program sufficient to guarantee at least a minimum return to said investor; and
designing said second insurance policy to allow said employee to borrow finds against said second insurance policy for meeting said investment objective.

35. The method of claim 31, further comprising:
said investor making annual investments into said business entity for at least a plurality of years; and
said employee making annual investments into said business entity for at least said plurality of years.

36. The method of claim 31, further comprising:
creating an operating agreement for said business entity wherein said employee is provided management status with respect to said business entity.

37. The method of claim 36, wherein said employee through said management status is enabled to make changes in investment allocations with respect to said second insurance policy.

38. A method for providing an employee benefit program, said method comprising:
determining, by an employer offering said employee benefit program, if said employer will finance an employee benefit of said employee benefit program with respect to a particular employee or if an outside investor will finance the employee benefit of said employee benefit program with respect to said particular employee, the one of said employer and said outside investor financing the employee benefit being a benefit investor;
determining how much money is to be invested with respect to said employee benefit based on goals of said benefit investor and said particular employee;
organizing a business entity to facilitate said employee benefit;
creating a business entity operating agreement providing the ability to allocate non-recourse and excess non-recourse debt and tax-free income as between said benefit investor and said particular employee;
determining how much of the business entity will be capitalized by each of said benefit investor and said particular employee;
designing a first policy to provide a guaranteed return to said benefit investor, said first policy being acquired by said business entity using funds of said business entity; and
designing a second policy to meet an investment objective of said particular employee, said second policy being acquired by said business entity using funds of said business entity.

39. The method of claim 38, wherein said first and second policies insure said particular employee.

40. The method of claim 38, wherein said first and second policies each comprise a universal life policy with investment options.
